(19) United States
(12) Patent Application Publication
(10) Pub. No.: US 2019/0137076 A1
(43) Pub. Date: May 9, 2019

(54) LIHT BULB WITH OPTICAL ELEMENT ACTING AS A TOTAL INTERNAL REFLECTION LIGHT GUIDE

(71) Applicant: PHILIPS LIGHTING HOLDING B.V., EINDHOVEN (NL)

(72) Inventors: PETER JOHANNES MARTINUS BUKKEMS, DEURNE (NL); JOHANNES PETRUS MARTIA ANSEMS, HULSEL (NL); ALDEGONDA LUCIA WEIJERS, EINDHOVEN (NL); SIMON EME KADIJK, EINDHOVEN (NL)

(21) Appl. No.: 16/305,876

(22) PCT Filed: Jun. 8, 2017
(86) PCT No.: PCT/EP2017/064008

§ 371 Date: Nov. 29, 2018

(30) Foreign Application Priority Data
Jun. 13, 2016 (EP) 16174107.9

(51) Int. Cl. F21V 7/00; F21K 9/232; F21V 29/70; F21V 29/503; F21V 29/504; F21V 23/06

(52) U.S. Cl. CPC F21V 7/0091; F21K 9/232; F21V 29/70; F21Y 2115/10; F21V 29/504; F21V 23/06; F21V 29/503

(57) ABSTRACT

A light bulb (1) is disclosed. The light bulb (1) comprises: a connector (2) for mechanically and electrically connecting the light bulb (1) to a light bulb socket; a light source (4) electrically connected to receive electrical power from the connector (2), wherein the light source (4) is separated from the connector (2) along a central axis (A) of the light bulb (1); and an internal structure (5) arranged along the central axis (A) between the connector (2) and the light source (4), wherein an axial direction is defined along the central axis (A) from the connector (2) towards the internal structure (5). The light bulb (1) further comprises a light-transmissive optical element (7) provided with an internal cavity (8) housing the light source (4) and the internal structure (5), the optical element (7) thereby forming an outer contour of the light bulb (1). The optical element (7) is optically separated from the internal structure (5), such that the optical element (7) acts as a total internal reflection light guide, preventing visibility of the internal structure (5) when the internal structure (5) is viewed at an angle to the axial direction and when said angle is smaller than a predefined threshold angle.

### TECHNICAL FIELD OF THE INVENTION

The present invention relates to a light bulb with an optical element that acts as a TIR (total internal reflection) light guide.

### BACKGROUND OF THE INVENTION

Visual aesthetics influence consumers' buying decisions for a wide range of products, including light bulbs. Some light bulb components are difficult to integrate into the overall light bulb design in an aesthetically pleasing way. Heat sinks are a case in point, and in order to address this problem they are sometimes made of a transparent material to make them less conspicuous. An example of a lighting device having a glass heat sink is disclosed in US 2015/0292725A1. Most common heat sink materials are, however, not transparent, and those that are tend to be either expensive or, like glass, relatively poor thermal conductors and therefore unsuitable for many applications, for example high-lumen light bulbs.

Other types of light bulb components present similar difficulties resulting from conflicting visual design, technical performance and cost requirements. There is a need for further efforts aimed at developing light bulbs that represent an attractive trade-off between technical performance, costs and aesthetics.

### SUMMARY OF THE INVENTION

In view of the foregoing, and according to a first aspect, there is provided a light bulb comprising: a connector for mechanically and electrically connecting the light bulb to a light bulb socket; a light source electrically connected to receive electrical power from the connector, wherein the light source is separated from the connector along a central axis of the light bulb; and an internal structure arranged along the central axis between the connector and the light source, wherein an axial direction is defined along the central axis from the connector towards the internal structure. The light bulb further comprises a light-transmissive optical element provided with an internal cavity which houses the light source and the internal structure, the optical element thereby forming an outer contour of the light bulb. The optical element is optically separated from the internal structure, such that the optical element acts as a TIR light guide, preventing visibility of the internal structure when the internal structure is viewed at an angle to the axial direction and when the angle is smaller than a predefined threshold angle.

Light rays reflecting off the internal structure and entering the surrounding optical element will, when subsequently striking the interface between the optical element and the air surrounding the light bulb, leave the optical element only if their angle with respect to the interface at the point of strike is such that the light ray does not undergo TIR. A light ray which is reflected back into the optical element continues to propagate therein until it strikes the air/optical element interface with an angle such that it can escape. Since the optical element has the shape of a bulb, the normal to the air/optical element interface varies from point to point, and the present invention is based on the realization that this can be used to control the TIR so as to provide a “hiding effect.” More precisely, by adapting the shape of the outer surface of the optical element appropriately, it is possible to ensure that the internal structure is not visible from some points of view. Since the optical element at least partially hides the internal structure, aesthetics do not need to be taken into account in the design of the internal structure. This facilitates the provision of a light bulb that represents an attractive trade-off between technical performance, costs and aesthetics. For example, it may be no problem at all to give the internal structure a shape that optimizes technical performance or is easy to produce, even though that shape is not visually appealing, and/or to make the internal structure of a material that represents the best choice from a technical or an economic perspective even though that material is a poor choice from a visual design perspective.

The light bulb is particularly suitable for applications in which it is mainly looked at from below and in which it is positioned so that the central axis is parallel to the vertical and the connector is at the bottom, because observers will then typically not see the internal structure. An example of such an application is one where the light bulb is mounted in a ceiling-mounted luminaire.

The internal structure may have an oblong shape with an end arranged distal to the connector, and the light source may be mounted on the distal end. An internal structure having such a shape facilitates positioning the light source so as to improve the spatial distribution of light.

The internal structure may be hollow so that a driver for powering the light source can be arranged inside the internal structure. Thus arranging the driver makes the light bulb compact and also contributes to the aesthetically pleasing appearance of the light bulb.

The internal structure may be a heat sink which is thermally connected to the light source in order to dissipate heat generated by the light source. Efficient thermal management is critical for many light bulbs, in particular high-lumen light bulbs, and a heat sink ensures adequate cooling so that the reliability and performance of the light bulb is maintained at a high level.

The heat sink may be thermally connected to the optical element, so that the optical element can help to absorb and dissipate heat. This promotes efficient cooling.

The internal structure and the optical element can be optically separated by an air gap. From a manufacturing standpoint this is an easy and inexpensive solution. Moreover, if the internal structure is a heat sink, this way of optically separating the internal structure and the optical element is especially advantageous because heat can then spread efficiently from the heat sink, through the thin air gap, to the optical element from which it is dissipated to the surrounding air.

The optical element may have an open end proximal to the connector and a closed end distal to the connector, the optical element narrowing towards the closed and open ends. Such an optical element can provide a suitable optical hiding effect and at the same time have a light bulb shape that is in demand commercially, for example the shape of a candle light bulb or a P light bulb.

The optical element may have a surface that faces the internal structure. A portion of that surface may be provided with a surface structure. Providing a portion of that surface with a surface structure means that light striking that portion will not undergo TIR or at least that there is less TIR occurring at that portion. The practical implication is that the structure will be projected, and enlarged, on the outer surface of the optical element, and this can be used to project an enlarged image on the outer surface that will be visible to observers.

The optical element can for example be made of glass or plastics. These materials are inexpensive and readily available commercially. In addition, from a manufacturing perspective, optical elements made of these materials are easy to shape so as to provide a desired threshold angle.

The light source may be a solid-state light source. Such light sources are energy efficient, reliable and have a long operational lifetime.

The connector may be connectable to an Edison screw socket. Such a connector makes the light bulb suitable for a wide range of applications.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 is an exploded view of a light bulb according to a first example embodiment of the invention.

FIG. 2 is a side view of the light bulb in FIG. 1.

FIGS. 3 and 4 are graphs based on theoretical calculations.

FIG. 5 is a side view of a light bulb according to a second example embodiment of the invention.

FIG. 6 is a side view of a light bulb according to a third example embodiment of the invention.

FIGS. 7 and 8 show cross-sectional top views of light bulbs.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION OF THE DRAWINGS

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

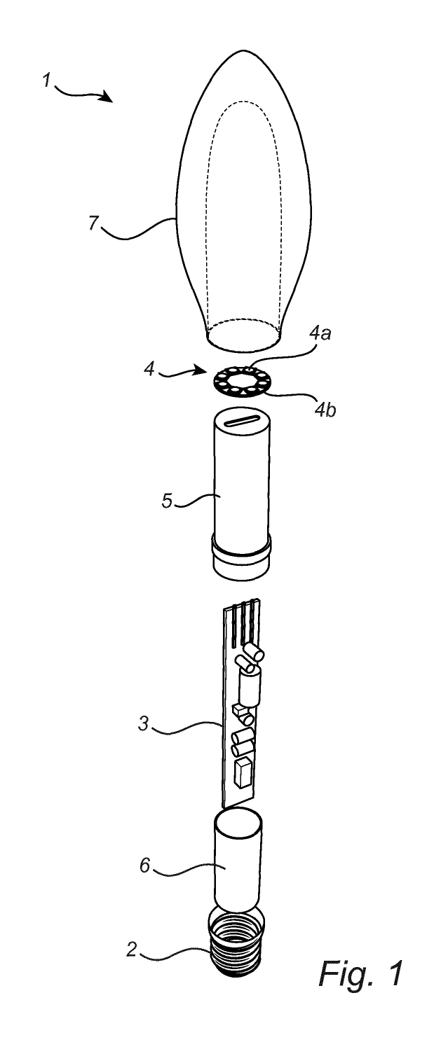

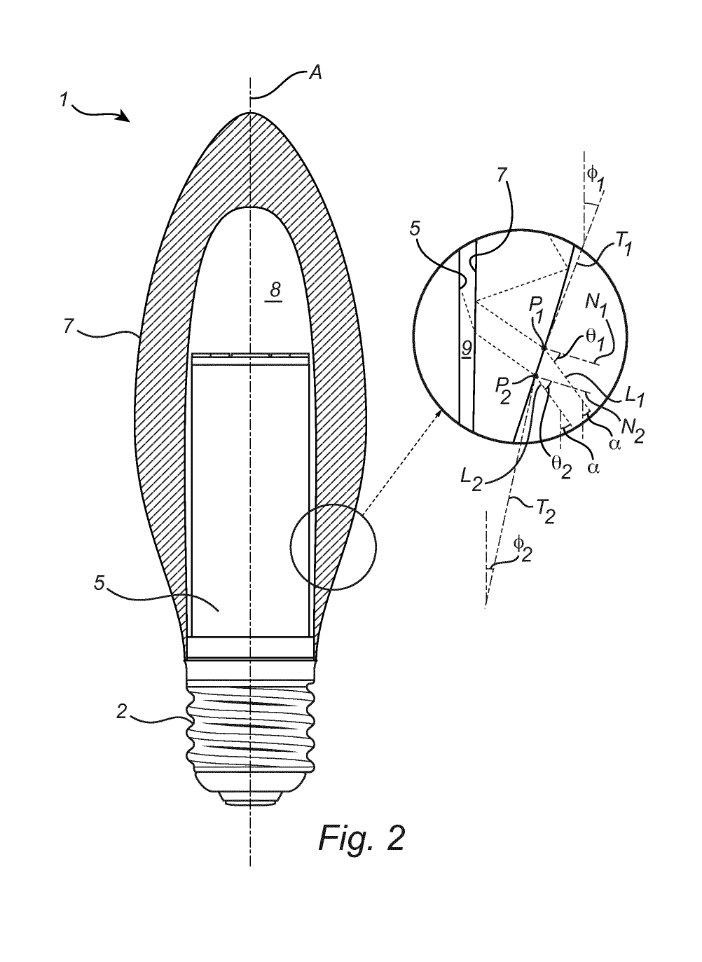

FIGS. 1 and 2 show a light bulb 1 that has a central axis A. The distribution of light emitted by the light bulb 1 is approximately rotationally symmetric around the central axis A. The light bulb 1 further has a connector 2 for mechanically and electrically connecting the light bulb to a light bulb socket. The connector 2 forms an end of the light bulb 1. In the illustrated example, the connector 2 is an Edison screw socket, but in other examples the connector 2 may be a bayonet connector or some other type of connector. The light bulb 1 is positioned so that the central axis A is parallel to the vertical, the connector 2 being at the bottom.

A driver 3 is electrically connected to the connector 2. The driver 3 comprises electrical circuitry for powering a light source 4 which is electrically connected to the driver 3. In the illustrated example, the light source 4 is a solid-state light source comprising several LEDs (light-emitting diodes) 4a mounted on a circuit board 4b. The circuit board 4b is a printed circuit board, but other types of circuit boards, such as wired circuit boards, are conceivable. The LEDs 4a may for example be semiconductor LEDs, organic LEDs or polymer LEDs. All of the LEDs 4a may be configured to emit light of the same color, for example white light, or different LEDs may be configured to emit light of different colors. It should be noted that in other examples light source 4 may have only one LED 4a.

The light source 4 is in thermal contact with a heat sink 5 which is adapted to transfer, or spread, heat away from the light source 4. The heat sink 5 forms an internal structure of the light bulb 1. The heat sink 5 is typically made of a metal, for example aluminum. In the illustrated example, the heat sink 5 has a hollow tubular shape. The heat sink 5 is arranged along the central axis A, one of the two ends of the heat sink 5 being proximal to the connector 2 and the other end being distal to the connector 2. The light source 4 is arranged on a flat portion of the distal end, so the heat sink 5 is arranged between the connector 2 and the light source 4. In the illustrated example, the LEDs 4a are arranged in a circle centered on the central axis A. The general direction of illumination of the LEDs 4a is in the axial direction, i.e. along the central axis A and away from the heat sink 5. The axial direction may equivalently be described as being directed along the central axis A from the connector 2 towards the heat sink 5.

The driver 3 is arranged in the inner space of the hollow heat sink 5. An isolator 6 is arranged between the driver 3 and the heat sink 5, the isolator 6 electrically isolating the driver 3 from the heat sink 5. The isolator 6 has a hollow tubular shape and is typically made of plastics, such as thermal plastics.

The light bulb 1 further comprises an optical element 7 which forms an outer contour of the light bulb 1. In the illustrated example, the overall shape of the optical element 7 is similar to a flame tip, something which makes the light bulb 1 especially suitable as a candle light bulb in for example a chandelier. Specifically, the optical element 7 has an open end proximal to the connector 2 and a closed end distal to the connector 2. The optical element 7 is widest between its ends and gradually gets narrower towards them. The optical element 7 is made of a light-transmissive material, for example a plastic material, such as polycarbonate, or glass. The optical element 7 is solid.

The driver 3, the isolator 6 and the heat sink 5 are housed in an internal cavity 8 of the optical element 7. The heat sink 5 faces the surface of the internal cavity 8. An air gap 9 optically separates the heat sink 5 from the optical element 7. That is to say, light cannot pass directly from the optical element 7 to the heat sink 5, and vice versa, but only via the air gap 9. The thickness of the air gap 9 is typically smaller than lmm, for example 0.1 mm, although the air gap 9 may be even smaller as long as TIR can occur. Heat can pass through the air gap 9, so the heat sink 5 and the optical element 7 are in thermal contact. Thus, heat generated by the light source 4 can be absorbed by the heat sink 5, then transferred, or spread, to the optical element 7 and finally dissipated to the ambient air. The mechanisms by which heat is dissipated from the optical element 7 to the ambient air are convection and thermal radiation.

The optical element 7 is adapted to act as a light guide that by TIR makes the heat sink 5 not visible from certain angles, and this “hiding effect” will now be discussed using a ray-tracing approach and with reference to FIG. 2. For the purpose of this discussion it will be assumed that the inner surface of the optical element 7, i.e. the surface that faces the heat sink 5, is vertically straight. This is not necessarily true in practice, for example due to draft angles or the optical element 7 being adapted to provide an especially strong hiding effect. It will also be assumed that the optical element 7 is made of polycarbonate having a refraction index of 1.59. Further, to simplify the discussion, the first and second light rays L₁, L₂ schematically illustrated in FIG. 2 are thought of as coming towards the light bulb 1 from the outside. The light rays that an observer actually sees are of course travelling in directions away from the light bulb 1, the first and second light rays L₁, L₂ thus merely serving as an illustrative aid for understanding the mechanism by which the optical element 7 hides the heat sink 5 from view for certain angles.

The first light ray L₁ strikes the outer surface of the optical element 7 at a point P₁. The surface tangent at point P₁ is denoted by T₁, and the tangent angle, i.e. the angle that the surface tangent T₁ makes with the vertical, is denoted by ϕ₁. The surface normal N₁ at point P₁ is perpendicular to the surface tangent T₁. The incident angle of the first light ray L₁, i.e. the angle that the first light ray L₁ makes with the surface normal N₁, is denoted by θ₁. Assuming that the incident angle θ₁ of the first light ray L₁ is 42.5°, it may be calculated that the first light ray L₁ will be refracted upon entering the optical element 7 and strike the inner surface of the optical element 7 with an angle 41° with respect to the normal to that surface, i.e. the horizontal. This is larger than the critical angle for TIR (arcsin (1/1.59)=38.97°), so the first light ray L₁ undergoes TIR.

The second light ray L₂ strikes the outer surface of the optical element 7 at a point P₂ which is located slightly below the point P₂ on the outer surface of the optical element 7. The surface tangent and the surface normal at point P₂ are denoted by T₂ and N₂, respectively. The outer surface of the optical element 7 is curved in such a way that the tangent angle θ₂ at point P₂ is smaller than the tangent angle ϕ₁ at point P₁. Assuming that the incident angle θ₂ of the second light ray 2 is 50.3°, it may be calculated that the second light ray L₂ will be refracted upon entering the optical element 7 and strike the inner surface of the optical element 7 with an angle 36.8° with respect to the normal to that surface, i.e. the horizontal. Since this angle is smaller than the critical angle for TIR (i.e. 38.97°, see above), the second light ray L₂ enters the air gap 9 and strikes the heat sink 5.

What this ray-tracing exercise in fact implies is that (i) an observer looking at point P₁ from the viewing angle α with respect to the vertical cannot see the heat sink 5 and (ii) an observer looking at point P₂ from the same viewing angle α can see the heat sink 5. This implies in turn that there is a threshold angle such that the heat sink 5 is not visible to an observer looking at the heat sink 5 from below at an angle with respect to the vertical that is smaller than the threshold angle. The threshold angle is predefined in the sense that it results from the optical element 7 having been provided with a particular shape. For example, the threshold angle can be made large by giving the optical element 7 a large horizontal width/diameter.

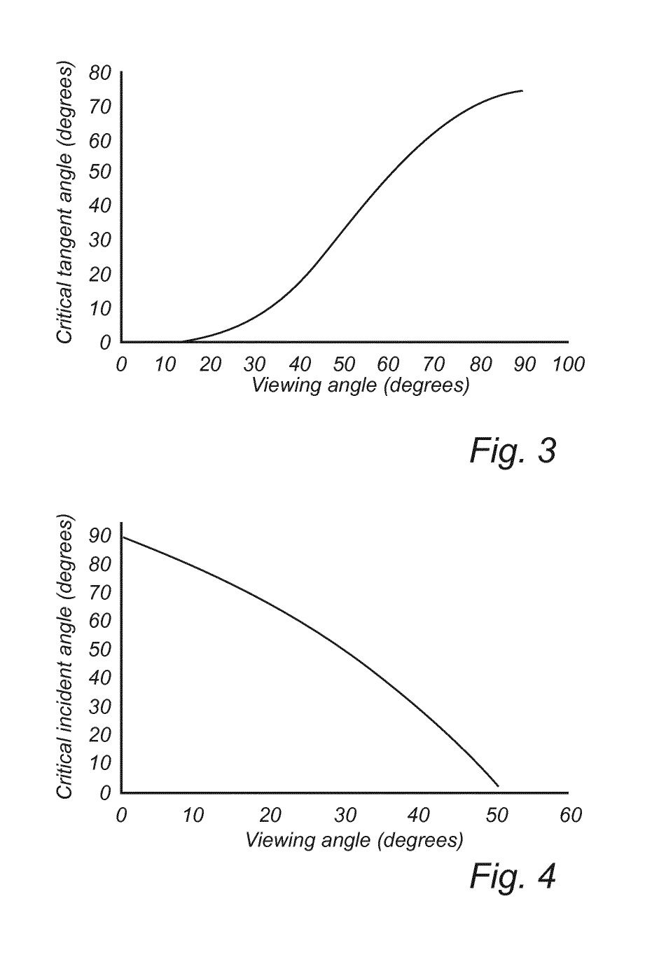

FIGS. 3 and 4 are graphs for further explanation of the “hiding effect.” The graphs are based on calculations for polycarbonate. FIG. 3 shows the critical tangent angle versus the viewing angle. Given a certain viewing angle, the critical tangent angle is such that an observer looking at a point on the optical element where the tangent angle is larger than the critical tangent angle cannot see the heat sink. Conversely, if the tangent angle is smaller than the critical tangent angle, the observer can see the heat sink. FIG. 4 shows the critical incident angle versus the viewing angle. Given a certain viewing angle, the critical incident angle is such that an observer looking at a point on the optical element where the incident angle is smaller than the critical incident angle cannot see the heat sink. Conversely, if the incident angle is larger than the critical incident angle, the observer can see the heat sink.

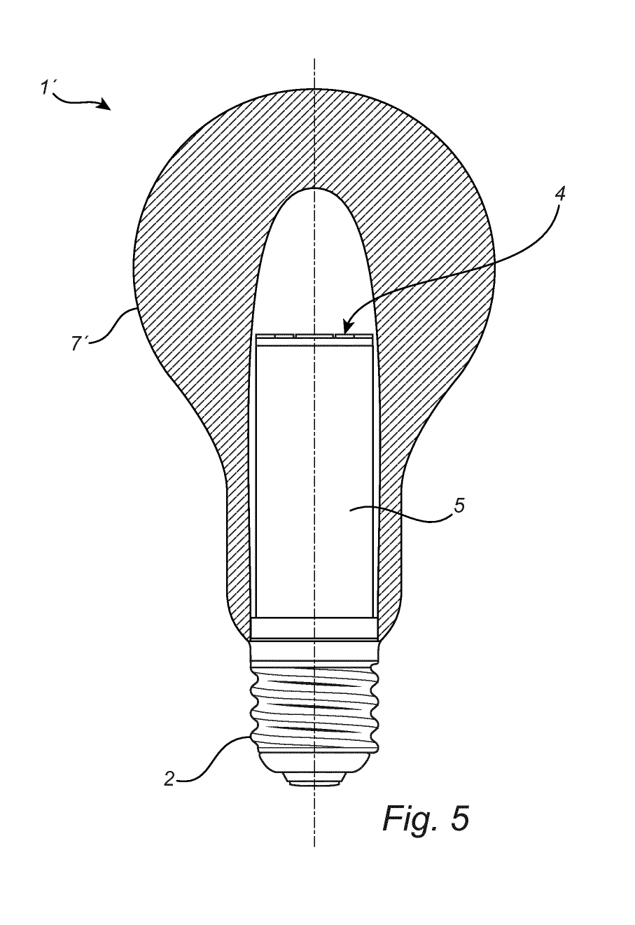

FIG. 5 shows a light bulb 1′ which is similar to the one in FIGS. 1 and 2 except in that the shape of the optical element 7′ of this light bulb 1′ is different. Specifically, the light bulb 1′ illustrated in FIG. 5 is a P-type light bulb, more precisely a P45 light bulb. Also, many other shapes of the optical element than this P-like shape and the candle-like shape of FIGS. 1 and 2 are of course possible.

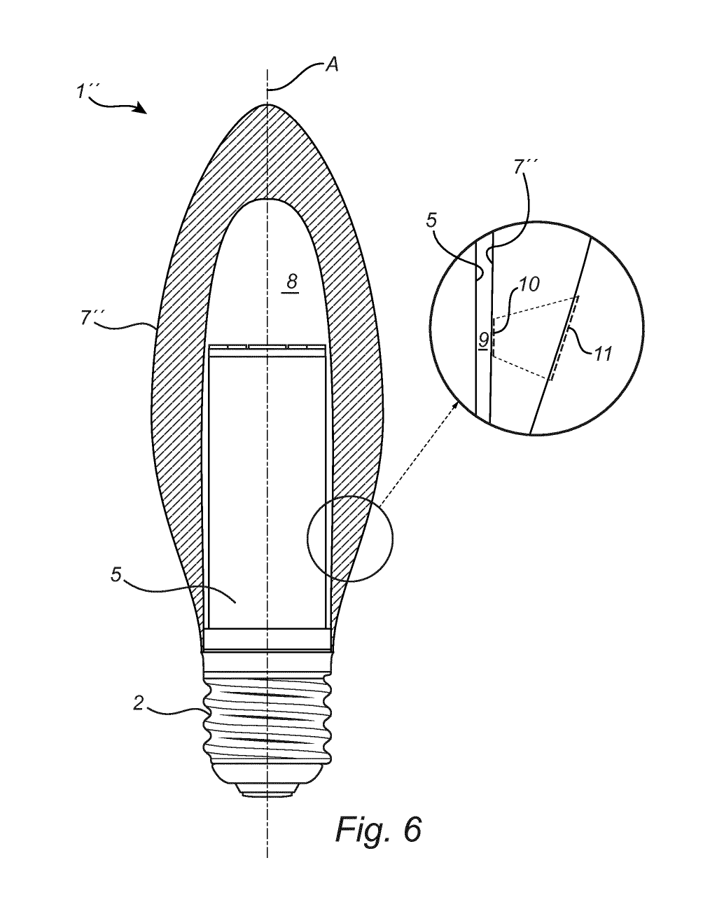

FIG. 6 shows a light bulb 1″ which is similar to the one in FIGS. 1 and 2 except in that, in FIG. 6, the surface of the optical element 7″ that faces the heat sink 5 has a portion provided with a surface structure 10. The surface structure 10 breaks the TIR interface and can for example be a surface roughness, a sticker, laser markings or paint, in particular white paint. The surface structure 10 may for example represent an image or a logotype which appears to an observer as a projection 11 on the outer surface of the optical element 7″.

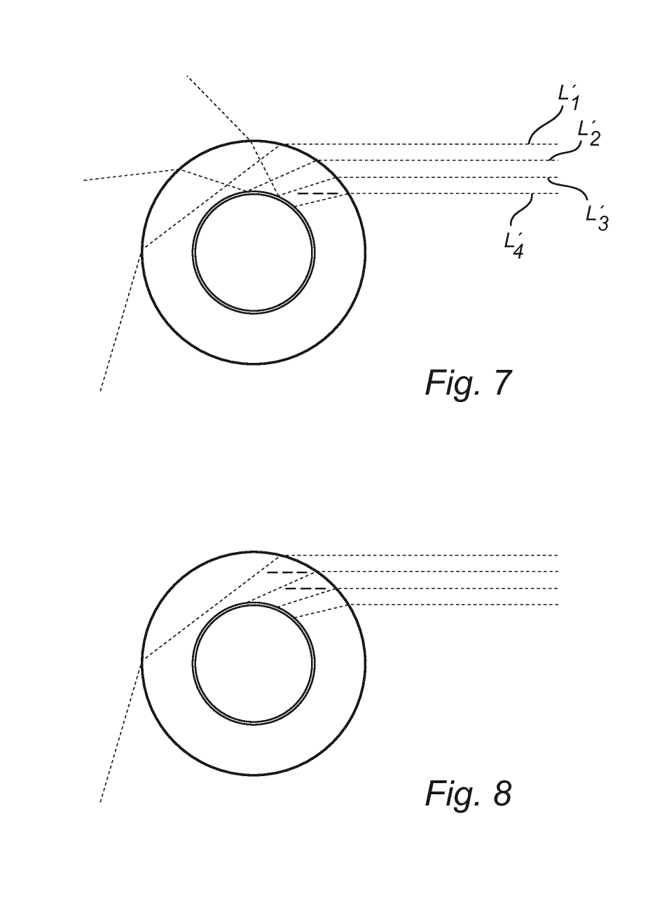

With reference to FIGS. 7 and 8, the mechanism behind the “imaging effect” of the surface structure 10 will be further explained. For illustrative simplicity, however, this will be done by way of analogy, more precisely by explaining what happens when a portion of the optical element makes optical contact with the sink.

FIGS. 7 and 8 each show a cross-sectional top view of a light bulb and four light rays that are intended to illustrate what an observer looking at the light bulb from the side sees. Turning first to FIG. 7, the first light ray L₁′ leaves the light bulb after two refractions. The second and third rays L₂′, L₃′ undergo TIR on the inner surface of the bulb. The fourth light ray L₄′ hits the heat sink, after refracting at the outer surface, and appears to an observer as if coming from the dashed line. Due to TIR at the inner surface, the observer does not see an enlarged heat sink (as a result of the lens effect of the outer bulb). However, if optical contact is made between the heat sink and the optical surface (or if the TIR is locally frustrated due to for example a surface roughness or white paint), the heat sink (or the portion which has a surface roughness) will appear enlarged. The dashed lines in FIG. 8 illustrate this effect and what an observer sees.

The person skilled in the art realizes that the present invention by no means is limited to the embodiments described above. On the contrary, many modifications and variations are possible within the scope of the appended claims. For example, the optical element may of course be used to hide other internal elements than heat sinks, such as an LED driver or an LED support. The present invention thus relates to light bulbs without heat sinks as well as light bulbs with heat sinks.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A light bulb comprising:
a connector for mechanically and electrically connecting the light bulb to a light bulb socket;
a light source electrically connected to receive electrical power from the connector, wherein the light source is separated from the connector along a central axis of the light bulb; and
an internal structure arranged along the central axis between the connector and the light source, wherein an axial direction is defined along the central axis from the connector towards the internal structure, characterized by a light-transmissive optical element provided with an internal cavity housing the light source and the internal structure, thereby forming an outer contour of the light bulb, wherein the optical element is optically separated from the internal structure, such that the optical element acts as a total internal reflection light guide, preventing visibility of the internal structure when the internal structure is viewed at an angle to the axial direction and when said angle is smaller than a predefined threshold angle, and
wherein the internal structure and the optical element are optically separated by an air gap, and said internal structure is in thermal contact with the optical element.

2. The light bulb according to claim 1, wherein the internal structure has an oblong shape with an end arranged distal to the connector, and wherein the light source is mounted on the distal end.

3. The light bulb according to claim 1, wherein the internal structure is hollow, and wherein a driver for powering the light source is arranged inside the internal structure.

4. The light bulb according to claim 1, wherein the internal structure is a heat sink thermally connected to the light source in order to dissipate heat generated by the light source.

5. The light bulb according to claim 4, wherein the heat sink is thermally connected to the optical element.

6. (canceled)

7. The light bulb according to claim 1, wherein the optical element has an open end proximal to the connector and a closed end distal to the connector, and wherein the optical element narrows gradually towards the closed end and the open end.

8. The light bulb according to claim 1, wherein the optical element has a surface facing the internal structure, and wherein a portion of said surface is provided with a surface structure.

9. The light bulb according to claim 1, wherein the optical element is made of glass or plastics.

10. The light bulb according to claim 1, wherein the light source is a solid-state light source.

11. The light bulb according to claim 1, wherein the connector is connectable to an Edison screw socket.
